(19) United States
(12) Patent Application Publication
(10) Pub. No.: US 2024/0060361 A1
(43) Pub. Date: Feb. 22, 2024

(54) CAMBERED WINDOW AND DOOR SCREENS

(71) Applicant: FlexScreen LLC, Export, PA (US)

(72) Inventor: Joseph A. Altieri, JR., Export, PA (US)

(21) Appl. No.: 18/275,260

(22) PCT Filed: Feb. 28, 2022
(86) PCT No.: PCT/US2022/018211

§ 371 Date: Aug. 1, 2023

Related U.S. Application Data
(60) Provisional application No. 63/154,804, filed on Feb. 28, 2021.

(51) Int. Cl. E06B 9/52

(52) U.S. Cl. CPC E06B 9/52; E06B 2009/527

(57) ABSTRACT

A cambered screen has multiple frame members that form a frame in a first plane. At least one of the members is cambered in a second plane that is transverse to the first plane. A screening mesh is applied to the frame to create the screen. When installed in a window or door frame channel, the cambered screen cooperates with the walls of the channel to secure the screen in the channel.

### REFERENCE TO PRIORITY DOCUMENTS

This application is an international application that claims the benefit of U.S. Provisional Application 63/154,804, filed Feb. 28, 2021, and entitled “Flexible Cambered Window and Door Screens,” the entire content of which is hereby incorporated as if more fully set forth herein.

### FIELD OF THE INVENTION

The present invention relates generally to apparatus, methods, and systems to assist with keeping insects from entering homes and businesses while still permitting fresh air flow. More specifically, the present invention relates to a window or door screen having improved stability in the channel of a window or door frame, but without any additional fastening or stability elements.

### BACKGROUND OF THE INVENTION

Certain window and door screens have a frame constructed of metal wire that is bent into a desired shape, such as a rectangle or square, and a screening mesh attached to the frame, and have become a popular alternative to traditional screens. By way of example, the flexible screens taught by the disclosure in U.S. Pat. No. 9,234,388, which is incorporated herein in its entirety, are typically held in place in a door or window opening in which they are intended to be used by way of parallel sides of their frame fitting within receiving grooves running along at least two parallel sides of the door or window opening. The '388 patent only teaches substantially planar screens.

The screens of the '388 patent are typically constructed using a metal wire having a spring-like characteristic that allows the screen frame leg members to be distorted when a force is applied to them and to return to their original shape when the force is removed. They are manufactured and sold both as an original screen installed at the factory in a new window, and as a replacement screen for an existing installation where the original screen is lost or damaged beyond repair.

Due to the width of the flexible screen in relation to the channel in which it is being used, securement in the window channel is sometimes preferable to keep the screen from rattling or falling out of the channel in windy conditions.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

Securing a window or door screen into a channel outside a window or door frame can be accomplished by introducing a cambered window or door screen having a frame and a screening mesh. The frame can have a plurality of adjoining leg members that contiguously form a defined shape substantially in a first plane and wherein at least one of the plurality of adjoined leg members is cambered in a second plane, the second plane being substantially transverse to the first plane. A screening mesh is affixed to the frame to complete the screen.

In certain embodiments, the frame is formed from a single piece of wire having a first end and a second end where the wire is bent in a plurality of locations and the ends are welded or otherwise permanently connected, whereby the defined shape for the screen is established.

Any number of screen frame members can be cambered. In some cases only one pair of opposing members are cambered, while in other cases, all of the members are cambered. Cambered members create a concave side and a convex side and, in certain embodiments, the screening mesh is adhered to the concave side

In certain other embodiments, a cambered window or door screen adapted for use with a window or door having a channel for receiving the screen; the flexible screen has a frame having a plurality of adjoined leg members that contiguously form a defined shape substantially in a first plane and a screening mesh affixed to the frame. At least one of the leg members is cambered in a second plane, transverse to the first plane, wherein the at least one cambered leg member engages with the channel to secure the screen within the channel. The amount of camber can be measured in the second plane by the amount of deflection of the ends of the cambered members to the center point of the cambered member. In embodiments, the amount of camber is greater than the width of the channel so that, in a resting state, the cambered screen applies pressure to both walls of the channel and is secured.

These and other features and advantages will be apparent from a reading of the following detailed description and a review of the appended drawings. It is to be understood that the foregoing summary, the following detailed description, and the appended drawings are explanatory only and are not restrictive of various aspects as claimed.

### BRIEF DESCRIPTION OF THE DRAWINGS

The accompanying drawings, which are incorporated in and form a part of the specification, illustrate the embodiments of the invention and together with the written description serve to explain the principles, characteristics, and features of the invention. In the drawings:

FIG. 1 is a perspective view of an embodiment of a flexible screen.

FIG. 2 is a front view of an embodiment of a flexible screen of the present disclosure.

FIG. 3 is a side elevation view of an embodiment of the screen.

FIG. 4 is a top elevation view of an embodiment of the screen.

FIG. 5 is a side elevation view of an embodiment of a screen placed in a channel of a window frame.

While implementations of the disclosed inventions are described herein by way of example, those skilled in the art will recognize that they are not limited to the embodiments or drawings described. It should be understood that the drawings and detailed description thereto are not intended to limit implementations to the particular form disclosed but, on the contrary, the intention is to cover all modifications, equivalents and alternatives falling within the spirit and scope as defined by the appended claims. The headings used herein are not meant to be used to limit the scope of the description or the claims.

### DETAILED DESCRIPTION OF THE INVENTION

In the following description, for purposes of explanation, numerous specific details are set forth in order to provide a thorough understanding of example embodiments. It will be evident to one skilled in the art, however, that embodiments can be practiced without these specific details. In some instances, well-known methods or components have not been described in detail so that the details of the present invention are not obfuscated.

In the interest of clarity, some routine features of the implementations described herein are omitted. It will be appreciated that in the development of any actual implementation of the present invention, certain decisions must be made in order to achieve specific goals, and that different decisions may be made to achieve different goals without departing from the teachings of the invention. While certain implementations might be complex and time-consuming, they would nevertheless be routine to accomplish for those of ordinary skill in the art having the benefit of this disclosure.

In certain embodiments, the screen frame disclosed herein is constructed of oil tempered flat wire, such as C1065 high carbon spring steel, having a width of about 0.09 inches and a thickness of about 0.225 inches. In another embodiment, the flat wire has a width of about 0.156 inches and a thickness of about 0.225 inches. In both examples, the wire has a natural round edge and a smooth clean finish and a tensile strength of 150/220 ksi. The width dimensions are provided by way of example only and are plus or minus about 0.002 inches. The thickness dimensions are provided plus or minus about 0.005 inches. In other embodiments, such as when cost or weight is an issue, a spring steel wire is used that is round in cross-section and approximately ⅛ (0.125) inches in diameter, plus another 0.005 inches or so for the coating. Channel width standards vary, but typically range from 5/16 (0.312) inches to 7/16 (0.437) inches, which is wider than both the flat wire and the diameter of the round wire discussed above.

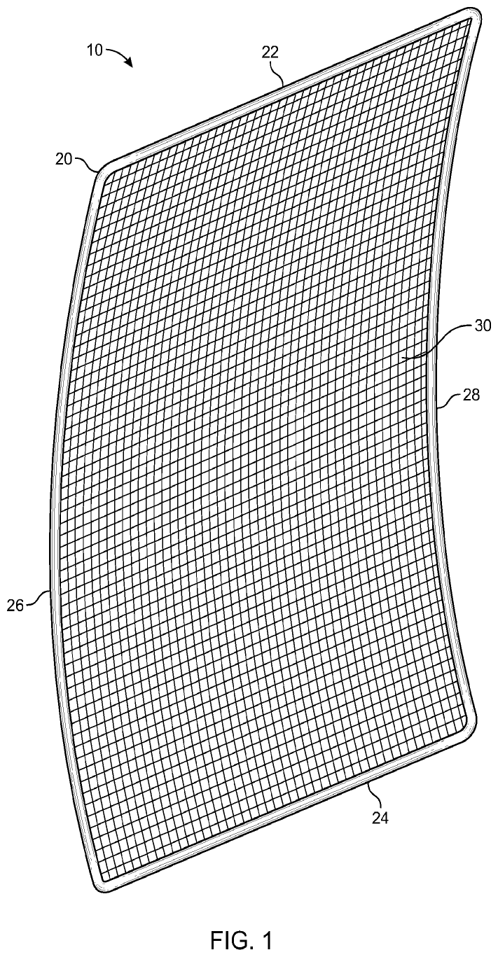

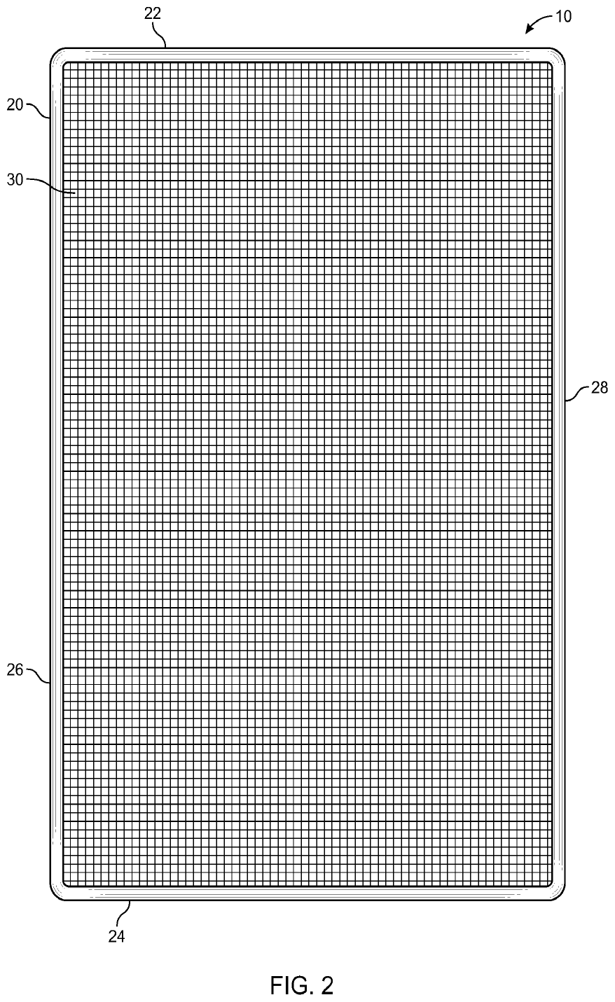

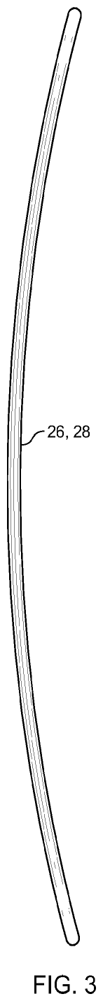

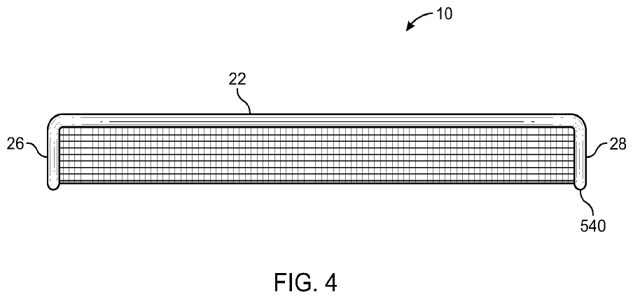

With reference to FIGS. 1-4, certain embodiments of the screen 10 of the present invention are constructed with a wire frame 20 and a screening mesh 30. In certain embodiments, the frame 20 has a circular cross-sectional shape. In other embodiments, the cross-sectional shape may be rectangular. The frame 20 has an upper horizontal member 22, a lower horizontal member 24, a first side member 26, and second side member 28. In embodiments, the frame is constructed from a single length of wire having a first end and a second end (not shown). The frame shape is constructed by bending the length of wire to nearly ninety degrees in four places to form the screen corners. To finish the screen frame, the first and second ends are connected at a single connection point (not shown). In certain embodiments, the connection is made in an area adjacent to one of the corners by way of welding, but other connection methods will be known to those of skill in the art, depending on the type of wire used.

In certain embodiments, the corners are bent to an angle of greater than 90 degrees, such as from 91 to 95 degrees, for example, in order to cause the members 22, 24, 26, 28 to naturally bend or arc away from the center of the screen. When the screen mesh is applied to the frame, the members are forced into a substantially rectangular formation, but the construction of the frame causes the members to bias outward, away from the center of the screen, to keep the screen mesh taut. Moreover, the screen construction, in conjunction with the spring-like characteristic of the wire, causes the screen be biased to resiliently return to its normal shape after deformation, such as when the screen is being inserted or removed from a window or door frame. Those of skill in the art will recognize that other screen shapes, besides a rectangle, are possible.

In certain embodiments, the longer side members of the frame 26, 28 are cambered. As used herein, the term “camber” or “cambered” is intended to mean curvature in a plane transverse to the plane of the screening mesh 30. See examples of this curvature in FIGS. 1, 3 and 5. The amount of camber of the side members 26, 28 will depend, in part, on the width of the channel the screen is designed to sit in, but will not be limited by this dimension as there could be excess camber for a particular channel width that ensures the screen fits in a more secure fashion than if the amount of camber was reduced to equal that of the width of the channel.

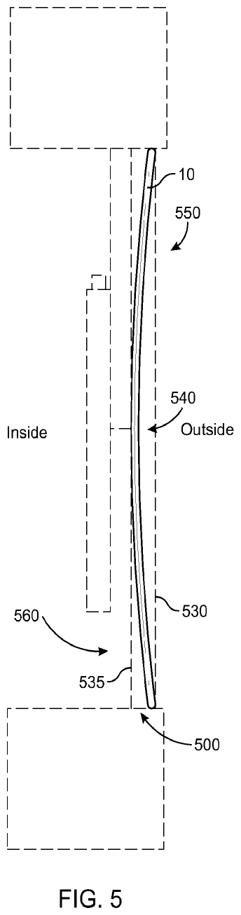

In certain embodiments, such as is illustrated in FIG. 5, the purpose of the cambered side members 26, 28 of the frame is to secure the screen 10 in the channel 500 so that it stays securely in place and does not rattle in the wind. When the side members 26, 28 are cambered, the upper horizontal member 22 and the lower horizontal member 24 are caused to press against the same side of the channel 500 when the screen 10 is placed in the channel 500.

In FIG. 5, for example, the upper horizontal member 22 and the lower horizontal member 24 are both contacting an outer channel wall 530; whereas a midpoint 540 of the first and second side members 26, 28 contacts the inner wall 535 of the channel. In this manner, the screen 10 is securely “wedged” into the channel 500. In certain other installation embodiments, the screen could be installed with the midpoint 540 contacting the outer channel wall 530 and the upper and lower horizontal members 22, 24 contacting the inner channel wall 535.

With further reference to FIG. 5, the screen 10 has a concave side 550 which is facing the outside of a building in FIG. 5. The screen 10 also has a convex side 560, which is facing the inside of the building in FIG. 5. In certain embodiments, the screening mesh 30 is adhered or otherwise affixed to the concave side 550 for the purpose of ensuring the screening mesh 30 is pulled taut when the screen 10 is installed in the channel 500.

In a example embodiment presented for purposes of further explanation, a screen 10 constructed in accordance with the present disclosure has side members thirty (30″) inches long that have a camber of 0.27 inches. Put another way, the screen 10, when placed on a flat surface with the upper horizontal member 22 and the lower horizontal member 24 touching the surface, the midpoint 540 would be raised above the flat surface by 0.27 inches. Those of skill in the art will recognize that increased side member lengths will likely call for additional camber and screens with shorter side member lengths may employ less camber. Moreover, different channel widths may further require greater or lesser amounts of camber over different distances in order to achieve the desired security.

Although embodiments with two cambered members have been illustrated, the present invention is not limited to that number. Should circumstances or design details warrant, any number of frame members can be cambered, from one to all, without departing from the scope of the invention. In certain window and door frames, there is only a channel on two of the four sides. In these embodiments, the screen need only be cambered where the channels exist.

It will be understood by those of skill in the art that the teachings of the present invention need not be limited to window and door screen frames that are flexible. Traditional screen frames made of aluminum, vinyl, or other suitable materials can also be cambered as disclosed herein with similar functional results.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure as come within known or customary practice in the art to which these teachings pertain.

1. A screen comprising:
a frame having a plurality of adjoined leg members that contiguously form a defined shape substantially in a first plane; and
a screening mesh affixed to the frame,
wherein at least one of the plurality of adjoined leg members is cambered in a second plane, the second plane being substantially transverse to the first plane.

2. The screen of claim 1, wherein the frame is formed from a single piece of wire having a first end and a second end, the wire is bent in a plurality of locations and the first end is adjoined to the second end, whereby the defined shape is established.

3. The screen of claim 1, wherein the screen comprises a first and second pair of opposing leg members, wherein the first pair of opposing members is cambered and the second pair of opposing members is substantially linear.

4. The screen of claim 3, wherein the first pair of opposing members is longer than the second pair such that the defined shape is a rectangle.

5. The screen of claim 1, wherein all of the contiguous leg members are cambered.

6. The screen of claim 1, wherein the frame further comprises a concave side and a convex side, and further wherein the screening mesh is affixed to the concave side.

7. A cambered window or door screen adapted for use with a window or door having a channel for receiving the screen, the screen comprising:
a frame having a plurality of adjoined leg members that contiguously form a defined shape substantially in a first plane; and
a screening mesh affixed to the frame,
wherein at least one of the plurality of adjoined leg members is cambered in a second plane, the second plane being substantially transverse to the first plane, and
wherein the at least one cambered leg member engages with the channel to secure the screen within the channel.

8. The screen of claim 7, wherein the frame is formed from a single piece of wire having a first end and a second end, the wire is bent in a plurality of locations and the first end is adjoined to the second end, whereby the defined shape is established.

9. The screen of claim 7, wherein the screen comprises a first and second pair of opposing leg members, wherein the first pair of opposing members is cambered and the second pair of opposing members is substantially linear.

10. The screen of claim 9, wherein the first pair of opposing members is longer than the second pair such that the defined shape is a rectangle.

11. The screen of claim 9, wherein the channel extends at least on opposing sides of the window or door frame and each of the first pair of opposing members engages with the channel to secure the screen.

12. The screen of claim 11, wherein the channel has a first wall and a second wall and each of the first pair of opposing members engages the first wall of the channel at a midpoint of the member and engages the second wall at each of two endpoints of the member, whereby the screen is secured in the channel.

13. The screen of claim 7, wherein all of the contiguous leg members are cambered.

14. The screen of claim 7, wherein the frame further comprises a concave side and a convex side, and further wherein the screening mesh is affixed to the concave side.

15. The screen of claim 7, wherein the cambered screen has a cambered width in the second plane and the channel has a channel width, the cambered width being greater that the channel width, whereby the cambered screen must be deflected to be inserted into the channel.
